(19) United States
(12) Patent Application Publication
(10) Pub. No.: US 2026/0163664 A1
(43) Pub. Date: Jun. 11, 2026

(54) Methods and Systems for System Time Recovery in Wireless Communication Devices

(71) Applicant: Zebra Technologies Corporation, Lincolnshire, IL (US)

(72) Inventors: Anandakumar Gopalsamy, Ronkonkoma, NY (US); Ohad Shatil, Dunwoody, GA (US)

(21) Appl. No.: 18/970,354

(22) Filed: Dec. 5, 2024

(51) Int. Cl. H04J 3/06; H04W 56/00; H04W 88/08

(52) U.S. Cl. CPC H04J 3/0661; H04W 56/0015; H04W 88/08

(57) ABSTRACT

A method in a wireless communication device includes: storing, in a memory of the wireless communication device: an identifier of a base station, a reference timestamp value indicating a duration of activity of the base station, and a reference time and date corresponding to the reference timestamp value; obtaining a current timestamp value from the base station; and updating a system time and date of the wireless communication device based on the reference time and date, and reference timestamp value, and the current timestamp value.

### BACKGROUND

A wireless communication device such as battery-powered mobile computer may maintain a system clock that is lost if the device is unpowered for a sufficient period of time. When the device is powered up after such a loss, the device may be unable to recover an accurate system time.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of a wireless communications system.

FIG. 2 is a diagram of certain internal components of a communications device in the system of FIG. 1.

FIG. 3 is a flowchart of a method of generating or updating system time recovery data.

FIG. 4 is a diagram illustrating example performances of the method of FIG. 3.

FIG. 5 is a flowchart of a method of system time recovery.

FIG. 6 is a diagram illustrating an example performance of the method of FIG. 5.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method in a wireless communication device, the method comprising: storing, in a memory of the wireless communication device: an identifier of a base station, a reference timestamp value indicating a duration of activity of the base station, and a reference time and date corresponding to the reference timestamp value; obtaining a current timestamp value from the base station; and updating a system time and date of the wireless communication device based on the reference time and date, and reference timestamp value, and the current timestamp value.

Additional examples disclosed herein are directed to a wireless communication device, comprising: a communications interface; and a memory storing: an identifier of a base station, a reference timestamp value indicating a duration of activity of the base station, and a reference time and date corresponding to the reference timestamp value; obtaining a current timestamp value from the base station; and a processor configured to: obtain a current timestamp value from the base station; and update a system time and date of the wireless communication device based on the reference time and date, and reference timestamp value, and the current timestamp value.

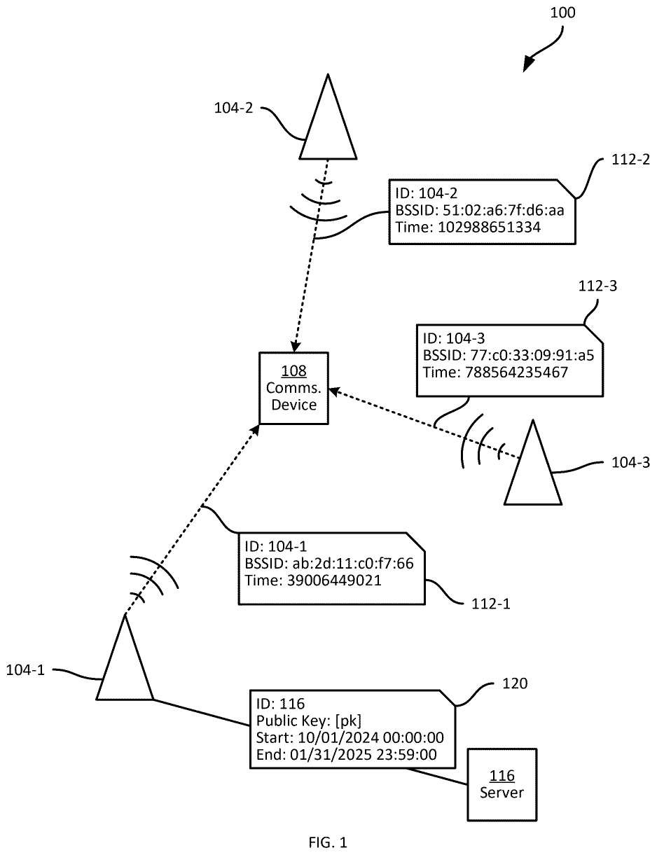

FIG. 1 illustrates a wireless communications system 100, including one or more wireless networks, such as wireless local area networks (WLANs) based on the Institute of Electrical and Electronics Engineers (IEEE) 802.11 family of standards (e.g., one or more Wi-Fi(TM) networks). In other embodiments, the system 100 can include one or more wide-area wireless networks (WWANs), such as cellular networks or the like, in addition to or instead of WLANs. As will be apparent in the discussion below, the functionality implemented in the system 100 can be applied to any of a variety of packet-switched wireless networks, including both local-area and wide-area networks. The system 100 can also include wired networks, e.g., interconnecting one or more of the wireless networks.

In the illustrated example, the system 100 includes a wireless network implemented by at least one base station, such as a wireless access point (AP) in the case of a WLAN. In the discussion below, the network is described as a WLAN, and the base stations are described as APs, but it will be understood that the functionality described herein can also be implemented in systems employing other forms of base station (e.g., gNB base stations in the context of cellular packet-switched networks).

The system 100 includes example access points 104-1, 104-2, and 104-3, which are referred to collectively as the access points 104, and generically as an access point 104. Similar nomenclature may also be used herein for other numbered components with hyphenated suffixes. The system 100 can include more than three access points 104, or fewer than three access points 104, in other examples. The access points 104 can implement a single WLAN, e.g., having a service set identifier SSID. In some examples, the access points 104 can be members of different WLANs with respective SSIDs (e.g., the APs 104-1 and 104-2 can be members of a given WLAN, and the AP 104-3 can be a member of another WLAN).

Each AP 104 can include an enclosure housing one or more controllers, transceivers, antenna assemblies, and the like. The APs 104 can be connected with a distribution subsystem (DS, not shown) or other infrastructure elements connecting the APs 104 to one another and/or to a wide area network.

Wireless communication devices, such as a wireless communication device 108 (also referred to herein as a device 108), can establish wireless connections with the APs 104 in order to communicate with the APs 104 and/or with other devices within the network and/or with other devices outside the network (e.g., via a gateway implemented by suitable network infrastructure). The system 100 can include more than one device 108 in other examples. The device(s) 108 of the system 100 can include any one of, or any suitable combination, of mobile computers, smartphones, mobile printers, barcode scanners, tablet computers, or the like. As will be apparent to those skilled in the art, the device 108 may be mobile, and the physical location of the device 108 relative to each of the APs 104 may therefore change over time. In such examples, the device 108 may therefore roam between the APs 104. In some examples, however, the device 108 need not be mobile.

The APs 104 can periodically broadcast beacons, e.g., data frames containing information that permits the device 108 (and various other wireless communication devices) to establish a connection with a corresponding AP 104, as well as to control medium access for connected devices. FIG. 1 illustrates respective beacons 112-1, 112-2, and 112-3 broadcast by the APs 104, and received at the device 108. The device 108 need not be connected with the WLAN(s) to receive the beacons 112. The beacons can also contain other information, as will be apparent to those skilled in the art, such as network capability indicators, scheduling information for contention-based access periods, and the like. Such information is omitted from FIG. 1 for clarity.

Each beacon 112 can include, for example, an identifier of the corresponding AP 104, e.g., in the form of a basic service set identifier (BSSID), a media access control (MAC) address, or the like. Each beacon 112 can also include a timestamp value, indicating a duration of activity of the AP 104. For example, the timestamp values can include a count, in microseconds, of the time elapsed since the AP 104 booted up. The timestamp value can be used for clock synchronization between APs 104 and client devices (such as the device 108) communicating with the network defined by the APs 104. The timestamp values generally do not indicate the current time and date (e.g., the day, month, year, and time of day). For example, the beacon 112-2 indicates that the AP 104-2 has been operational for 102988651334 microseconds, or about 28 hours. The timestamp values can be, for example, 8-byte values contained in the timestamp field defined in the 802.11 standards, and/or in a vendor-specific information element in the beacons 112.

The device 108 maintains a system time, e.g., an indication of the current date and time that is local to the device 108 (e.g., maintained by a processor or other suitable controller of the device 108). A variety of operations at the device 108 may employ the system time. For example, the device 108 may assess the validity of security certificates received from other computing devices using the system time. For example, to establish a connection with a server 116 via the WLAN defined by the APs 104, the device 108 may initiate a handshake process with the server 116 in which the device 108 and the server exchange security certificates. A security certificate 120 for the server may contain, for example, a public key [pk] of the server 116 used to establish encrypted communications with the server 116. The certificate 120 can also define a validity period, e.g., by a start time and date (e.g., midnight on Oct. 1^{st}, 2024), and an end time and date (e.g., one minute before midnight on Jan. 31, 2025). The validity period can have other lengths than the three months shown in FIG. 1.

The device 108 can be configured to determine, before establishing a secure connection with the server 116, whether the certificate 120 is valid, for example by comparing a system time at the device 108 with the validity period of the certificate 120. If the system time is outside the validity period, the device 108 may determine that the certificate 120 is invalid, and abort the connection process. In some cases, the certificate 120 may be invalid, e.g., because an operator of the server 116 failed to renew the certificate 120 upon its expiry.

Under some conditions, however, the certificate 120 may be valid, but the system time of the device 108 may be incorrect. For example, the device 108 may maintain the system time in volatile memory, e.g., in a register of a controller, in random access memory (RAM), or the like. If such volatile memory loses power, the system time may therefore also be lost. Loss of power can occur, for example, if a primary power source such as a rechargeable battery, mains power, or the like, is removed or discharged and a backup battery (e.g., capable of sustaining low-level functions such as system time maintenance) is also discharged. In some cases, the device 108 may recover an accurate system time when the device 108 is powered on again, e.g., from a cellular network or the like. In other cases, however, the device 108 may lack a connection with a network with the ability to serve time and date information.

The device 108, in such examples, may revert to a persistently stored time and date (e.g., in non-volatile memory). Such a time and date may correspond to an operating system installation date or the like, and may therefore be weeks or months old. For example, the device 108 may recover a system time of May 14, 2024 from persistent storage. In such an example, the device 108 would determine that the certificate 120 is not valid, because the starting point of the validity period appears to be in the future. The device 108 may therefore be unable to establish a secure connection with the server 116 until the system time is manually updated at the device 108.

Loss of system time may be mitigated by periodically caching (e.g., once per day), to persistent storage at the device 108, a current system time. However, the above certificate validity issue may still arise with such caching, e.g., if a start or end of the validity period of the certificate 120 falls after the most recent cached system time and the device 108 loses power before the next caching operation. More frequent caching of system time (e.g., hourly or more frequently) may reduce the likelihood of incorrect certificate validity decisions, but may not eliminate them. High-frequency caching of system time and date (e.g., once per minute) may substantially eliminate such issues, but imposes a greater burden on the computational and storage resources of the device 108.

As discussed below, the device 108 is configured to implement functionality permitting the device 108 to recover an accurate system time in the event of power loss, while mitigating the need for high-frequency caching of system time and date values. The device 108 employs timestamp values from the beacons 112 in the recovery function, storing beacon timestamp value(s) from one or more APs 104 and system date/times corresponding to the moment(s) those timestamp values were captured. Subsequently, by capturing a further timestamp value from an AP 104 for which an earlier timestamp value was captured, the device 108 can determine, based on the difference between the timestamp values for that AP 104 and the stored previous system time and date, a current time and date.

As will be apparent to those skilled in the art, the timestamp values are unlikely to roll over (e.g., rollover for a 64-bit value defining a count of microseconds would take more than half a million years), but the APs 104 are likely to periodically reboot, e.g., due to software updates, power losses, or the like. The timestamp values may therefore also be reset at unpredictable intervals. The system time recovery functions implemented by the device 108 also reduce the likelihood of setting a system time erroneously based on recently-reset timestamp values (e.g., a timestamp value reset by the corresponding AP 104 later than the previous timestamp value for that AP 104 stored at the device 108).

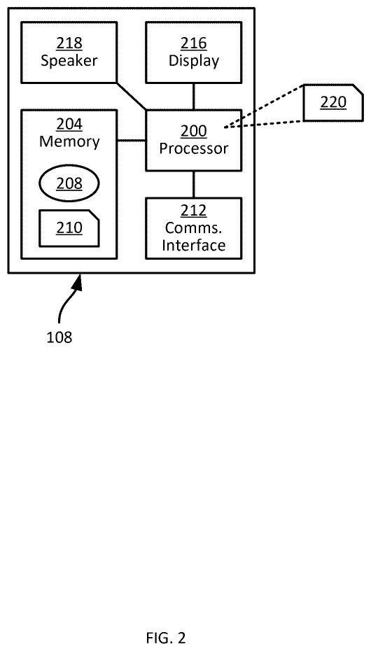

Prior to describing the system time recovery functionality implemented by the device 108 in detail, certain internal components of the device 108 are shown in FIG. 2. The device 108 includes a processor 200, such as a central processing unit (CPU), graphics processing unit (GPU), application-specific integrated circuit (ASIC), or the like, communicatively coupled with a non-transitory computer-readable storage medium such as a memory 204, e.g., a combination of volatile memory elements (e.g., random access memory (RAM)) and non-volatile memory elements (e.g., flash memory or the like). The memory 204 stores a plurality of computer-readable instructions in the form of applications, including in the illustrated example a system time recovery application 208, whose execution by the processor 200 configures the device 108 to maintain system time recovery data 210 (e.g., a file, lookup table, or the like), the contents of which is described further below.

The device 108 also includes a communications interface 212, enabling the device 108 to establish connections with networks such as the network implemented by the APs 104. The communications interface 212 can therefore include any suitable combination of transceivers, antenna elements, and corresponding control hardware enabling communications with the APs 104. In some examples, the functionality implemented by the application 208 can be implemented within the communications interface 212, e.g., in the form of firmware instructions or the like stored at the interface 212 and executed by either or both of a dedicated controller of the interface 232 and the processor 200. The processor 200, memory 204, and communications interface 212 can be implemented as components of a system-on-chip (SoC) assembly, in some examples. The device 108 can also include input devices such as a touch screen, a microphone, a camera, or the like, and output devices such as a display 216, a speaker 218, and the like.

The device 108 can maintain a system time 220, e.g., defining a current time and day with any suitable precision (e.g., down to a microsecond). The system time 220 can be volatile, e.g., maintained in a registry or the like of the processor 200. The system time 220 can therefore, as noted earlier, be lost if the device 108 loses power.

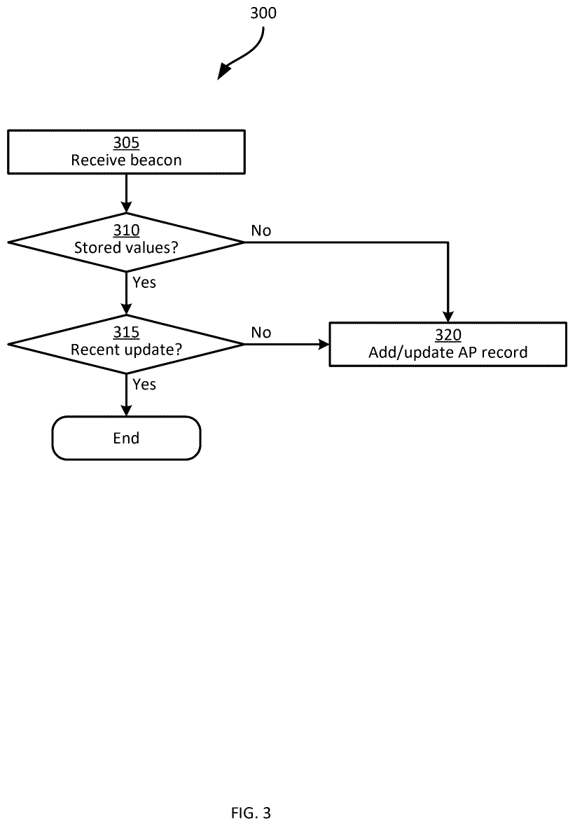

Turning to FIG. 3, a method 300 of generating or updating system time recovery data, such as the system time recovery data 210 shown in FIG. 2. The method 300 is described below in conjunction with its performance by the device 108, for example via the execution of the application 208 by the processor 200 and/or a controller of the communications interface 212. The method 300 can be performed by the device 108 to populate and/or update the system time recovery data 210, for subsequent use in verifying and/or recovering system time. The device 108 can be configured, prior to beginning the method 300, to validate the system time 220. Validating the system time 220 can be performed via the functionality described herein, and/or via communications with the server 116 or another suitable data source.

At block 305, the device 108 is configured to receive a beacon 112 from an AP 104. The device 108 need not have established a connection with that AP 104, or with any of the other APs 104, to detect a beacon 112. As will be apparent, the device 108 can perform multiple instances of the method 300, e.g., one instance per beacon detected at the communications interface 212. For example, an instance of the method 300 can be performed upon receiving the beacon 112-1 shown in FIG. 1.

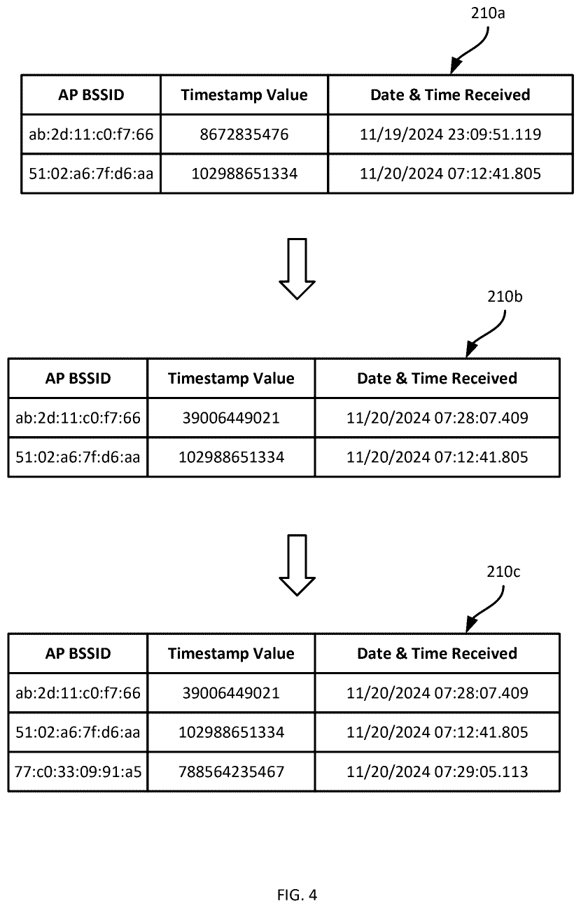

At block 310, the device 108 is configured to determine whether the system time recovery data 210 contains information corresponding to the AP 104 from which the beacon was received at block 305. Turning to FIG. 4, system time recovery data 210a is shown, including two records corresponding to the AP 104-1 and 104-2, respectively. As noted in connection with FIG. 1, each beacon 112 includes an identifier of the AP 104 that broadcast the beacon 112, such as a BSSID. The device 108 is configured to store the BSSID (or other suitable identifier) in the data 210, and the determination at block 310 therefore includes determining whether the data 210 includes an AP identifier that matches the identifier in the beacon from block 305. The determination at block 310 is affirmative in this example, and the device 108 proceeds to block 315.

At block 315, the device 108 can be configured to determine whether the values stored in the data 210 associated with the AP 104 (the AP 104-1 in this example) have been updated recently. For example, as shown in FIG. 4, each record in the data 210 includes an identifier of an AP 104, a reference timestamp value extracted from a beacon 112 of that AP 104 (e.g., 39006449021 for the AP 104-1), and a reference time and date value (e.g., Nov. 19, 2024 23:09:51.119) corresponding to the system time 220 at the time the timestamp value was captured. At block 315 the device 108 can determine whether a difference between the reference time and date and the system time 220 is smaller than a predetermined threshold, e.g., one hour. A wide variety of other thresholds can also be employed, including thresholds shorter than an hour or longer than an hour. When the determination at block 315 is affirmative, indicating that the corresponding reference time and date and timestamp value have been recently updated, performance of the method 300 ends. In other words, block 315 may serve to avoid unnecessarily frequent updates to the data 210. As will be apparent to those skilled in the art, the APs 104 may broadcast beacons 112, for instance, every 100 milliseconds, and updating the data 210 multiple times per second may be excessive.

In this example, the system time 220 is Nov. 20, 2024 07:28:07.409 when the beacon 112-1 is received, which is about eight hours later than the reference time and date stored in connection with the AP 104-1. The determination at block 315 is therefore negative, and the device 108 proceeds to block 320. At block 320, the device 108 is configured to update the reference timestamp value according to the beacon 112-1, e.g., replacing the value “8672835476” with the value “39006449021”. FIG. 4 illustrates updated data 210b resulting from the above performance of the method 300.

In another example performance of the method 300, e.g., in response to detection of the beacon 112-3 at the device 108, the determination at block 310 is negative and the device 108 therefore proceeds directly to block 320. FIG. 4 illustrates a further updated version of the data 210c, in which a record has been inserted corresponding to the AP 104-3. Through periodic performances of the method 300, therefore, the device 108 can maintain a set of reference timestamp values and corresponding system times (also referred to as reference times, or reference times and dates).

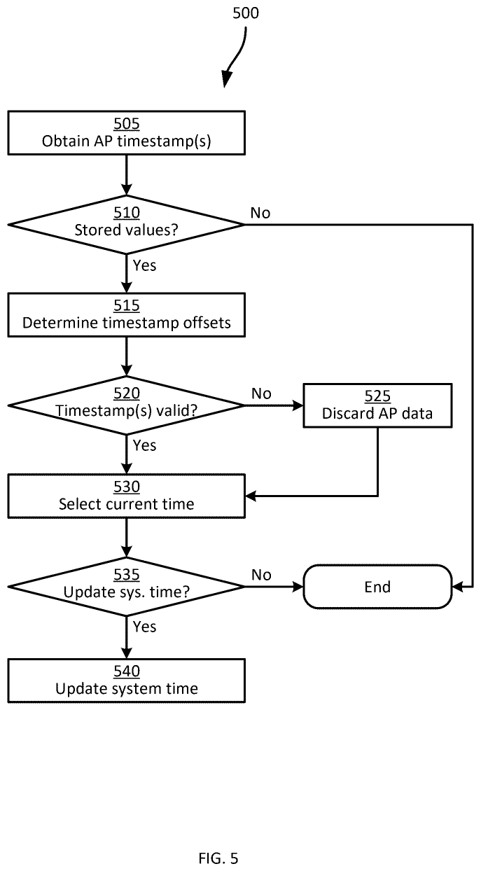

Turning to FIG. 5, a method 500 of system time recovery is illustrated. The method 500 is described below in conjunction with its performance by the device 108, for example via the execution of the application 208 by the processor 200 and/or a controller of the communications interface 212. The method 500 can be initiated, for example, in response to the device 108 powering on, rebooting, or the like. When the method 500 is initiated, or before the method 500 is initiated, the system time 220 is set. Setting the system time, e.g., if the device 108 has lost power and therefore lost a previous system time 220, can include retrieving a cached system time. The system time 220 may, in other words, be inaccurate. Performance of the method 500 serves to validate and/or correct the system time 220.

At block 505, the device 108 is configured to obtain one or more timestamp values from the APs 104. For example, the device 108 can monitor a predetermined set of communication channels for beacons 112 for a predetermined amount of time (e.g., one second, although a wide variety of other time periods can also be used), collecting any detected beacons 112 during that period. At block 510, the device 108 is configured to determine whether any beacons 112 were received from APs 104 represented in the data 210 (e.g., in the data 210c as shown in FIG. 4). If the determination at block 510 is negative, indicating that no beacons 112 were received at block 505 from the APs 104 identified in the data 210c, performance of the method 500 ends. In the absence of any beacons 112 from previously identified APs 104, the device 108 may be unable to autonomously validate or correct the system time 220.

When at least one beacon 112 from an AP 104 identified in the data 210c was received at block 505, the determination at block 510 is affirmative, and the device 108 proceeds to block 515. At block 515, the device 108 is configured to determine offsets between the reference timestamp values in the data 210c and the corresponding timestamp values from the beacons 112 received at block 505. Each offset can be determined by, for example, subtracting the reference timestamp value from the current timestamp value (that is, the value obtained at block 505 for a given AP 104).

At block 520, the device 108 is configured to determine whether each of the timestamp values from block 505 with corresponding reference timestamp values in the data 210c are valid. Determining whether a timestamp value is valid can include determining whether the offset from block 515 is negative. If an offset is negative, the timestamp value from block 505 is smaller than the reference timestamp value, indicating that the corresponding AP 104 has been rebooted since the corresponding record in the data 210c was last updated. There is therefore no association between the reference time and date and the current timestamp (that is, from block 505), and the reference timestamp value and the reference time and date are therefore no longer valid. The device 108 can therefore discard the reference timestamp value and the reference time and date for that AP 104 at block 525. When the determination at block 520 is affirmative for a given timestamp value (e.g., for a given AP 104), the corresponding record in the data 210c is retained. The device 108 is configured to repeat the determination at block 520 for each timestamp value obtained at block 505 and for which the data 210c contains a record.

Following the performance of block 520 (and, as necessary, block 525) for each timestamp value, at block 530, the device 108 is configured to select a current time and date. If no timestamp values from block 505 were found valid, at block 530 the device 108 is configured to keep the system time 220 set prior to initiating the performance of the method 500 (which may be inaccurate). If a single timestamp value was found valid, at block 530 the current time selected at block 530 is based on the valid timestamp value. For example, the device 108 can be configured to add the offset from block 515 for the valid timestamp value to the corresponding reference time and date in the data 210c to determine a current time and date. When more than one timestamp value is valid, the device 108 can determine a candidate current time and date for each valid timestamp value, and select one of the candidates. The device 108 can, for example, select the highest (e.g., the latest) candidate time and date. In other examples, the device 108 can be configured to select the candidate time and date representing the 80^{th} percentile among the candidates. As will be apparent, a wide variety of other selection mechanisms can be implemented.

At block 535, the device 108 can be configured to determine whether to update the system time 220 according to the selected current time from block 530. The determination at block 535 can include determining whether a difference between the selected current time and date and the system time 220 exceeds a threshold (e.g., one hour, although various other thresholds can also be used). When the difference is below the threshold, the system time 220 may be sufficiently likely to be correct that updating the system time 220 may be unlikely to avoid issues such as erroneously invalidating security certificates. When the determination at block 535 is negative, therefore, the device 108 can retain the system time 220. When the determination at block 535 is affirmative, the device 108 replaces the system time 220 with the selected current time and date from block 530.

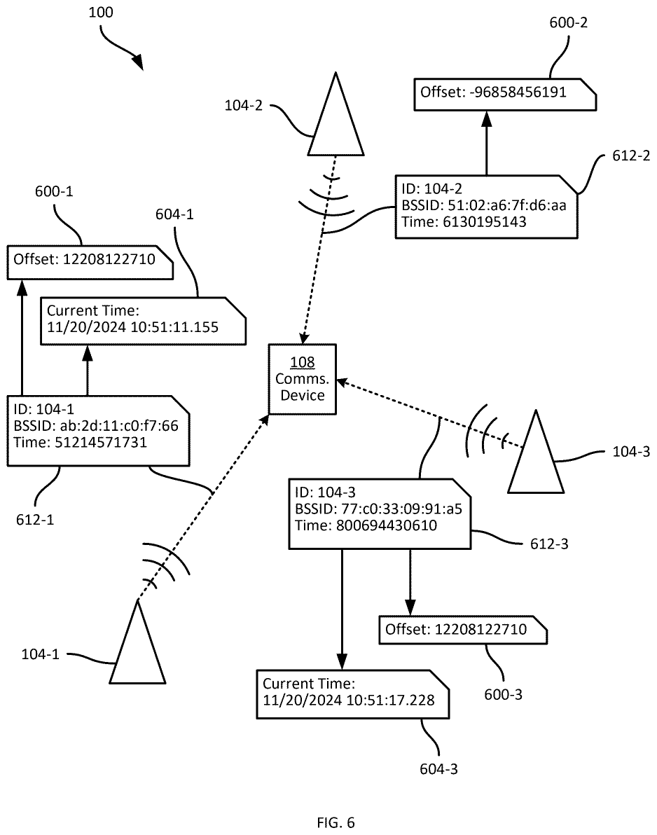

Turning to FIG. 6, an example performance of the method of FIG. 5 is illustrated. At block 505, the device 108 may receive beacons 612-1, 612-2, and 612-3, containing AP 104 identifiers and timestamp values as discussed earlier. At block 510, the device 108 determines that all three beacons 612 corresponding to APs 104 that are represented in the data 210c. At block 515, the device 108 determines offsets 600-1, 600-2, and 600-3. As seen in FIG. 6, the offset 600-2 is negative, indicating that the AP 104-2 has been restarted since the corresponding record in the data 210c was last updated. The determination at block 520 for the AP 104-2 is therefore negative, and the record in the data 210c corresponding to the AP 104-2 is therefore discarded at block 525.

At block 530, the device 108 is configured to determine current times 604-1 and 604-3 corresponding to the valid timestamp values for the APs 104-1 and 104-3. The device 108 can be configured to select, for example, the latest of the determined current times (e.g., the time 604-3), and following a determination that the time 604-3 exceeds the system time 220 by a given threshold (e.g., an hour), set the current time 604-3 as the system time 220.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a wireless communication device, the method comprising:
storing, in a memory of the wireless communication device:
an identifier of a base station,
a reference timestamp value indicating a duration of activity of the base station, and
a reference time and date corresponding to the reference timestamp value;
obtaining a current timestamp value from the base station; and
updating a system time and date of the wireless communication device based on the reference time and date, the reference timestamp value, and the current timestamp value.

2. The method of claim 1, wherein obtaining the current timestamp value includes receiving a beacon message from the base station, the beacon message containing the current timestamp value.

3. The method of claim 1, wherein updating the system time and date comprises:
determining a difference between the reference timestamp value and the current timestamp value;
adding the difference to the reference time and date to obtain a current time and date; and
setting the current time and date as the system time and date.

4. The method of claim 3, further comprising:
prior to setting the current time and date as the system time and date, determining that a difference between the current time and date and the system time and date exceeds a threshold.

5. The method of claim 3, further comprising:
prior to setting the current time and date as the system time and date, determining that the difference between the reference timestamp value and the current timestamp value is positive.

6. The method of claim 1, further comprising:
storing, in the memory, an identifier of a second base station, a second reference timestamp value, and a second reference time and date corresponding to the second reference timestamp value;
obtaining a second current timestamp value from the second base station; and
prior to updating the system time, selecting between the current timestamp value and the second current timestamp value.

7. The method of claim 6, wherein the selecting comprises:
determining a first current time and date based on the current timestamp value;
determining a second current time and date based on the second current timestamp value; and
selecting the latest of the first current time and date and the second current time and date.

8. The method of claim 1, further comprising:
subsequent to updating the system time, receiving a beacon message from the base station, the beacon message containing an updated reference timestamp value;
replacing the reference timestamp value in the memory with the updated reference timestamp value; and
replacing the reference time and date in the memory with an updated time and date corresponding to receipt of the beacon message.

9. The method of claim 1, further comprising:
subsequent to updating the system time, receiving a beacon message from a second base station; and
storing, in the memory:
an identifier of the second base station,
a second reference timestamp value indicating a duration of activity of the second base station, and
a second reference time and date corresponding to the second reference timestamp value.

10. The method of claim 1, wherein the base station is a Wi-Fi base station.

11. A wireless communication device, comprising:
a communications interface; and
a memory storing:
an identifier of a base station,
a reference timestamp value indicating a duration of activity of the base station, and
a reference time and date corresponding to the reference timestamp value;
obtaining a current timestamp value from the base station; and
a processor configured to:
obtain a current timestamp value from the base station; and
update a system time and date of the wireless communication device based on the reference time and date, and reference timestamp value, and the current timestamp value.

12. The wireless communication device of claim 11, wherein the processor is configured to obtain the current timestamp value by receiving a beacon message from the base station, the beacon message containing the current timestamp value.

13. The wireless communication device of claim 11, wherein the processor is configured to update the system time and date by:
determining a difference between the reference timestamp value and the current timestamp value;
adding the difference to the reference time and date to obtain a current time and date; and
setting the current time and date as the system time and date.

14. The wireless communication device of claim 13, further wherein the processor is configured to:
prior to setting the current time and date as the system time and date, determine that a difference between the current time and date and the system time and date exceeds a threshold.

15. The wireless communication device of claim 13, wherein the processor is configured to:
prior to setting the current time and date as the system time and date, determine that the difference between the reference timestamp value and the current timestamp value is positive.

16. The wireless communication device of claim 11, wherein the memory stores an identifier of a second base station, a second reference timestamp value, and a second reference time and date corresponding to the second reference timestamp value; and wherein the processor is configured to:
obtain a second current timestamp value from the second base station; and
prior to updating the system time, select between the current timestamp value and the second current timestamp value.

17. The wireless communication device of claim 16, wherein the processor is configured to select between the current timestamp value and the second current timestamp value by:
determining a first current time and date based on the current timestamp value;
determining a second current time and date based on the second current timestamp value; and
selecting the latest of the first current time and date and the second current time and date.

18. The wireless communication device of claim 11, wherein the processor is configured to:
subsequent to updating the system time, receive a beacon message from the base station, the beacon message containing an updated reference timestamp value;
replace the reference timestamp value in the memory with the updated reference timestamp value; and
replace the reference time and date in the memory with an updated time and date corresponding to receipt of the beacon message.

19. The wireless communication device of claim 11, wherein the processor is configured to:
subsequent to updating the system time, receive a beacon message from a second base station; and
store, in the memory:
an identifier of the second base station,
a second reference timestamp value indicating a duration of activity of the second base station, and
a second reference time and date corresponding to the second reference timestamp value.

20. The wireless communication device of claim 11, wherein the base station is a Wi-Fi base station.
